(19) United States
(12) Patent Application Publication
(10) Pub. No.: US 2019/0005031 A1
(43) Pub. Date: Jan. 3, 2019

(54) ACCESSING CLOUD BASED DOCUMENT LIBRARIES OVER UNRELIABLE NETWORKS

(71) Applicant: INTERNATIONAL BUSINESS MACHINES CORPORATION, Armonk, NY (US)

(72) Inventors: Manish Kataria, Delhi (IN); Manu Kuchhal, Muzaffarnagar (IN)

(21) Appl. No.: 15/635,336

(22) Filed: Jun. 28, 2017

(51) Int. Cl. G06F 17/30; H04L 29/08

(52) U.S. Cl. CPC G06F 17/30011; H04L 67/10

(57) ABSTRACT

Accessing cloud based document libraries over unreliable networks is provided. The method includes a service hub on a client device locating a requested document in a local archive on the client device. If the requested device is found in the local archive, the service hub queries the server computer to determine which version of the requested document is more current. The determination is made by comparing the metadata associated with the document version in the local archive and the metadata of the document version on the server computer. If the server version is more current, the service hub requests a full download of the requested document, and updates the local archive with the retrieved metadata and document contents.

### FIELD

The present disclosure relates generally to the field of cloud computing, and more particularly, to accessing cloud based document libraries over slow or unreliable networks.

### BACKGROUND

The quality of internet access, especially the speed and reliability of the networks, may affect the success of a cloud based application. Users in developing countries may frequently encounter issues of speed and reliability. Consequently, these users may experience both frustrating response times and uncertain reliability, which may result in applications not being able to gain popularity and acceptance in such developing countries.

### BRIEF SUMMARY

According to an embodiment, a method for accessing cloud based document libraries over unreliable networks is provided. The method includes a service hub on a client device locating a requested document in a local archive on the client device. If the requested device is found in the local archive, the service hub queries the server computer to determine which version of the requested document is more current. The determination is made by comparing the metadata associated with the document version in the local archive and the metadata of the document version on the server computer. If the server version is more current, the service hub requests a full download of the requested document, and updates the local archive with the retrieved metadata and document contents.

According to another embodiment, a computer program product for accessing cloud based document libraries over unreliable networks is provided. The computer program product includes program instructions to locate a requested document, by a service hub on a client device, in an archive on the client device, wherein the archive includes a plurality of documents and metadata associated with each of the plurality of documents. Program instructions are included to retrieve metadata associated with the requested document from a document library on a server computer, whereby the requested document is located in the archive on the client device. Program instructions compare metadata associated with the requested document in the archive on the local device to metadata associated with the requested document from the document library on the server computer. Program instructions receive the requested document from the document library on the server computer, whereby the document from the document library on the server is more current than the requested document in the archive on the client device. Program instructions update the metadata and document in the archive on the local device.

In another embodiment, a computer system for accessing cloud based document libraries over unreliable networks is provided. The computer system includes one or more processors, one or more tangible computer-readable storage devices, and a plurality of program instructions stored on at least one of the one or more storage devices for execution by at least one of the one or more processors. The program instructions locate a requested document, by a service hub on a client device, in an archive on the client device, wherein the archive includes a plurality of documents and metadata associated with each of the plurality of documents. The program instructions retrieve metadata associated with the requested document from a document library on a server computer, whereby the requested document is located in the archive on the client device. The program instructions compare metadata associated with the requested document in the archive on the local device to metadata associated with the requested document from the document library on the server computer. The program instructions receive the requested document from the document library on the server computer, whereby the document from the document library on the server is more current than the requested document in the archive on the client device. The program instructions update the metadata and document in the archive on the local device.

### BRIEF DESCRIPTION OF THE SEVERAL VIEWS OF THE DRAWING

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an example of a system environment, according to an embodiment of the present disclosure;

FIG. 2 depicts an exemplary embodiment of retrieving a document from a cloud based document library;

FIG. 3 depicts an exemplary embodiment of publishing a document to a cloud based document library; and

FIG. 4 is a schematic block diagram of hardware and software of the computer environment according to an embodiment of the method of FIGS. 2-3.

### DETAILED DESCRIPTION

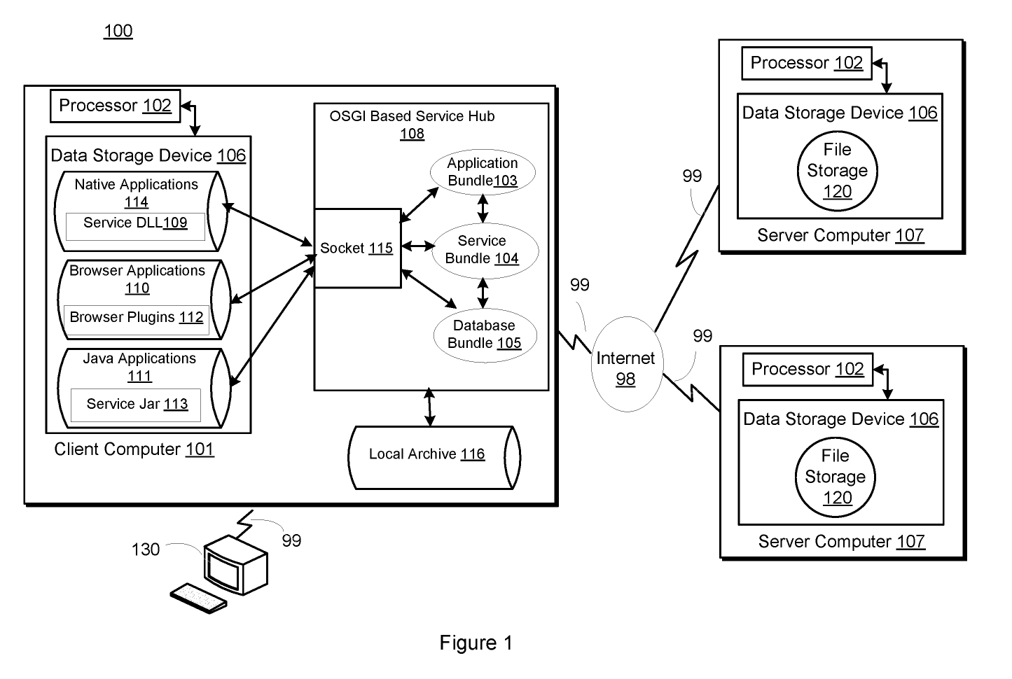

Embodiments of the present invention are described with reference to the figures. FIGS. 1-4 depict an exemplary implementation for accessing cloud based document libraries over networks that may be slow or unreliable. The present disclosure relates to the field of cloud computing, and more particularly, to accessing cloud based document libraries. The following described exemplary embodiments provide a method, system, and program product to, among other things, avoid unnecessarily retrieving documents from cloud based document libraries. Therefore, the present embodiments have the capacity to improve the field of cloud computing by reducing unnecessary network traffic, especially in developing countries where the internet service is unreliable, slow, or not widely available. Conserving the scarce resource of network bandwidth can encourage the development and acceptance of cloud based applications, by avoiding network consumption for unnecessary document downloading.

FIG. 1 depicts an exemplary embodiment of a computer system 100 for accessing cloud based document libraries over slow or unreliable networks. In this example, the computer system 100 may include a client computer 101 and one or more server computers 107. The one or more server computers 107 host repositories of content in various formats, such as documents, photos, videos, and music. Hereinafter, the various content formats are referred to as documents. The client computer 101 may include a workstation/laptop, a smartphone, or other similar devices. The client computer 101 includes an OSGI based service hub (service hub) 108 that accepts requests from applications on the client computer 101 to retrieve or publish content and format the requests for the server computer 107.

The OSGI service hub (service hub) 108 is a software framework that runs on the client computer 101. The service hub 108 intercepts requests from applications running on the client computer 101 for retrieving or publishing documents. Such applications may include a web browser, music and/or video player, or document editor. The service hub 108 communicates with the client's applications through a socket 115. The socket 115 conforms to the OSGI standard and is therefore platform independent. The service bundle 104 portion of the service hub 108 provides a registry for the application bundles 103. The service bundle 104 allows an application bundle 103 to either dynamically add itself as a new service, or to withdraw itself as an existing service from the service hub 108 registry. The database bundle 105 provides the local archive 116, which is encrypted database storage for document metadata, retrieved documents, and documents that are ready to publish. The local archive 116 schema is flexible and may be designed depending on the requirements of the application. However, to properly identify a document, particularly when the same document can be retrieved from different sources, the schema can include at least: documentID, document name, versionID, a uniform resource location (URL) to identify the source of the document, checksum, a field identifying the user or process that created the document, the user or process that last modified the document, document size, type of document, and the actual document content. The checksum can be derived from a cryptographic hash algorithm that is executed against digital content to detect errors which may have been introduced during its transmission or storage. The checksum can also help identify document versions. For example, if the checksums are equal, the documents are likely the same, whereas differing checksums indicate that the contents of the documents differ. Various dates and times may be included, such as created date, last modified date, last modified time, last accessed date, last accessed time, and created time.

Each client computer 101 and server computer 107 includes at least one processor 102 and at least one storage device 106. The data storage device 106 provides the file storage 120 for the various documents and document libraries that are subject to client request. The client computer 101 may be implemented in several hardware and software configurations, as may be the server computer 107. In one configuration, the client computer 101 may additionally include an administrative client computer 130, also having at least one processor and at least one storage device. In another configuration, the client computer 101 may be a smartphone, laptop, or similar mobile device. Although the client computer 101 can be an individual device, the client computer 101 can include an enterprise-class computer that executes the service hub 108 and provides a local archive 116 that is accessed by multiple users company-wide.

Each computer (and administrative client) communicates over a network 99. The network 99 may include various types of communication networks, such as a wide area network (WAN), local area network (LAN), a telecommunication network, a wireless network, a public switched network and/or a satellite network. Additionally, the client computer 101 may request documents that are hosted on the one or more server computers 107.

Various software vendors, such as Dropbox, FileNet, Mozilla, and others, may provide application program interfaces (API) for developing software applications using their products. The client computer 101 may include several software applications (110, 111, 114), stored on one or more data storage devices 106. Each software application (110, 111, 114) can access a vendor-provided API, for example, to retrieve metadata about a document from a document library. Each software application (110, 111, 114) can be written in the same or different coding language. For example, compiled applications, also referred to as native applications 114 may be written in C, C++, COBOL, or similar language. The native application 114 provides a portion of its code as an executable file that acts as an interface that is appropriate to the operating system of the client computer 101. Here, a service Dynamic-link Library (DLL) 109 is shown, which is an executable format for the Windows operating system. (Microsoft, Windows, and the Windows logo are trademarks of Microsoft Corporation in the United States, other countries, or both.) Similarly, a web browser application 110 provides browser plugins 112, and a Java application 111 provides a service jar 113. Each application interface is written to conform to the OSGI standard.

The particular description in FIG. 1 is for illustrative purposes only; it should be understood that the invention is not limited to specific described embodiments, and any combination is contemplated to implement and practice the invention.

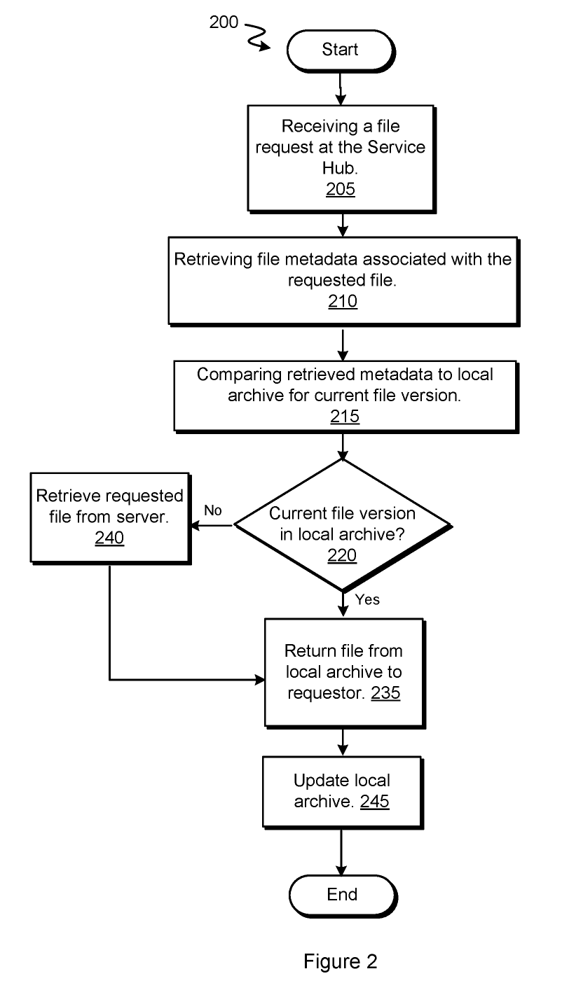

FIG. 2 is a method for retrieving a document from cloud based document libraries over a network, including over the internet 98. In the first example, at 205 the service hub 108 receives a request from one or more of the applications (114, 110, and 111) on the client computer 101 to retrieve a document. For example, a web-based application receives a command from the user to retrieve a document, such as by recognizing clicking on a download button.

In the step at 210, the appropriate application in the service hub 108, in this example the browser application 110 and browser plugins 112, intercepts the browser command before the web-based application begins the download. The browser application 110 and browser plugins 112, using the vendor-supplied API, requests from the document library the metadata associated with the requested document. The request can be keyed by the documentID which can uniquely identify the document in both the document library and the local archive 116. That is, the document library may uniquely identify entries by a documentID. The service hub 108 may use that documentID, either alone or in combination with other metadata fields, to create a unique document identifier in the local archive 116. The service hub 108 then accesses the metadata in the in the client computer's local archive 116 to determine whether the requested document is already resident at the client computer 101. For example, the service hub 108 can compare various metadata fields associated with the requested document with those in the local archive 116, including: documentID, the document name, versionID, checksum, a field identifying the user or process that created the document, the user or process that last modified the document, document size, and type of document. The service hub 108 can check the last modified date, last modified time, created date and created time in the retrieved metadata against those dates in the local archive 116.

If, at 220, the requested document is not in the local archive 116, the service hub 108 allows the requested document to download (240).

However, the comparison of the retrieved metadata can indicate that the requested document is in the local archive 116, but with a different version number. If the local archive 116 contains a later version, the download does not continue, since the local archive 116 has the more current version. However, if the version in the document library is later, then the download of the requested document continues. Applications on the client computer 101 may continue to their next operation, i.e., function, instead of being blocked while waiting to be notified of the request completion. At 235, the service hub 108 returns the requested document to the requesting application. At this point, the document is in the local archive 116, either because it was added during step 240, or because the local archive 116 already contained the most current version. The service hub 108 then updates the local archive 116, at 245. For a downloaded document, this step includes adding the database entry uniquely identifying the document in the local archive 116, and inserting the document contents and metadata. Here, the metadata includes that which was retrieved from the document library, such as documentID, the document name, versionID, checksum, a field identifying the user or process that created the document, the user or process that last modified the document, document size, and type of document, created date and created time, and URL that was the source of the document. The schema of the local archive 116 can include additional fields not originally retrieved in metadata from the document library. For example, the local entry can include a last accessed date and time to indicate when the local archive 116 was accessed.

For a document that was retrieved from the local archive 116, the service hub 108 can update the last accessed date and time. Although FIG. 2 shows the requested document being returned to the requesting application prior to updating the local archive 116, in another embodiment, the updating can occur either prior to, or concurrently with, returning the requested document to the requesting application.

Although the method of FIG. 2 is described in the context of a web-based application executing from the service hub 108 on a client computer 101, the method can similarly apply to accessing documents from cloud based document libraries, such as FileNet or Dropbox. It should be noted that two applications, such as Dropbox and a web browser, can execute concurrently on the client computer 101 and concurrently request a document. As one skilled in the art of application programming may acknowledge, each application executes in its own context. Generally, this means that each application has at least its own memory, cache, variables, and execution stack. Neither application is aware of the other's existence or context. Therefore, the browser application 110 API and a Java application 111 (or native application 114), each will request to download the document from their respective document library. Two separate requests are initiated because neither requestor is aware of the other's context. Also, the two requests may be for the same document (including version), but from different sources. Therefore, the service hub 108 can service each request independently and concurrently. In this case, the URL of the source of the document, along with the other metadata described above, is used to determine whether the local archive 116 contains the document. Several results are possible after executing the method of FIG. 2. For example, neither document is in the local archive 116 and both documents are downloaded. Also, both documents are in the local archive 116 and neither documents are downloaded. Finally, only one of the documents is in the local archive 116, but the other document is not, and is downloaded.

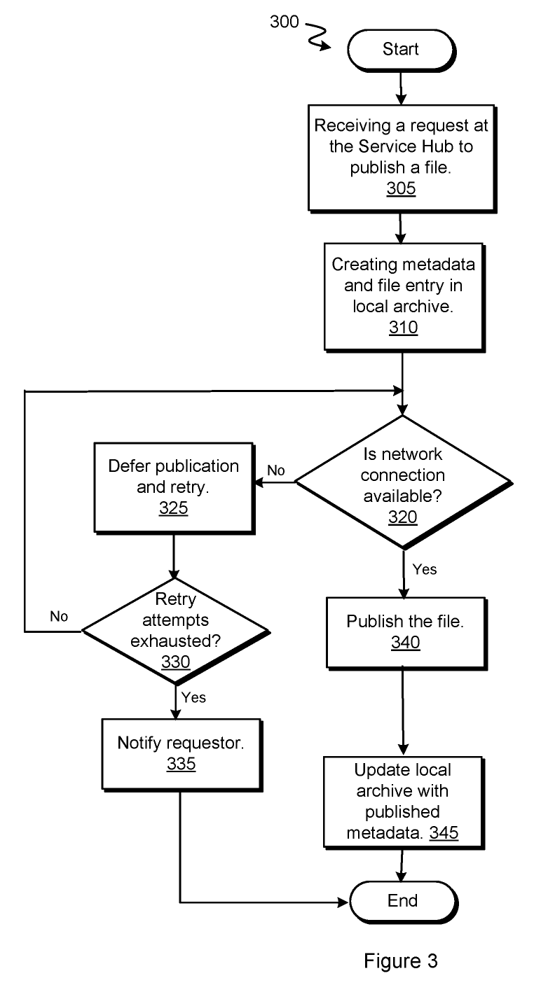

FIG. 3 is an exemplary embodiment of publishing a document to a cloud based document library over a network, including over the internet 98. For example, a document author/editor can directly publish a document from Microsoft Office (Office) to a web application, such as Dropbox, using an Office API. In the case of Office, the document can include a spreadsheet, drawing, slide presentation, or other Office document formats.

At 305, the browser plugins 112 intercepts the operation to publish the document. At 310, before continuing, the service hub 108 saves the document to the local archive 116, which includes adding the document content to the local archive 116, creating a database entry uniquely identifying the document, and creating the metadata for the document. The metadata for the document is substantially the same as that described previously with reference to FIG. 2. This is to ensure that the document is saved in its final form in case the network connection fails during the upload to the destination. At 320, the service hub 108 attempts a connection to the destination URL. If successful, the destination URL accepts the document, according to the destination URL's application protocols, and the document is published (at 340). At 345, the document metadata is updated in the local archive 116, if necessary, such as with an indication of success and a date and time the document was published. However, if at 325, the network connection is not available, the service hub 108 will defer publication. Since the document and its associated metadata is stored in the local archive 116, the risk of a failure, or corruption during transmission is avoided.

The service hub 108 may include a profile that is configurable by the end user. The profile can include a count of maximum retry attempts, an amount of time between retry attempts, and a preferred time window (i.e., a start and end time) to attempt publication. The end user can set the profile parameters to best take advantage of when a reliable network connection is likely. At 330, if the maximum retry attempts is not reached, the service hub 108 will return to 320 to attempt publication. If the publication fails again, the number of retry attempts is decremented, and publication is attempted again (320). The number of retry attempts may become exhausted, at 330. In that case, at 335 the service hub 108 notifies the requesting application, which may send an alert to the end user.

As another example, the end user has previous published a document to a cloud based document library, such as Dropbox, executing the method of FIG. 3. The local archive 116 contains the published document, and the associated metadata and versionID uniquely identifying the document. Subsequently, the end user updates the document in the service hub 108. This causes the service hub 108 to update the document metadata, including updating the versionID. According to the method of FIG. 2, the end user attempts to download the document at the document library, using the Office supplied extension in Dropbox. The appropriate browser application 110 and browser plugins 112 intercept the command to Office and retrieves document metadata from Dropbox. Following the comparison of the retrieved metadata to that in the local archive 116, the download does not occur because the more recent version is locally resident. In an embodiment, the end user may optionally be prompted to override the action and download the document anyway.

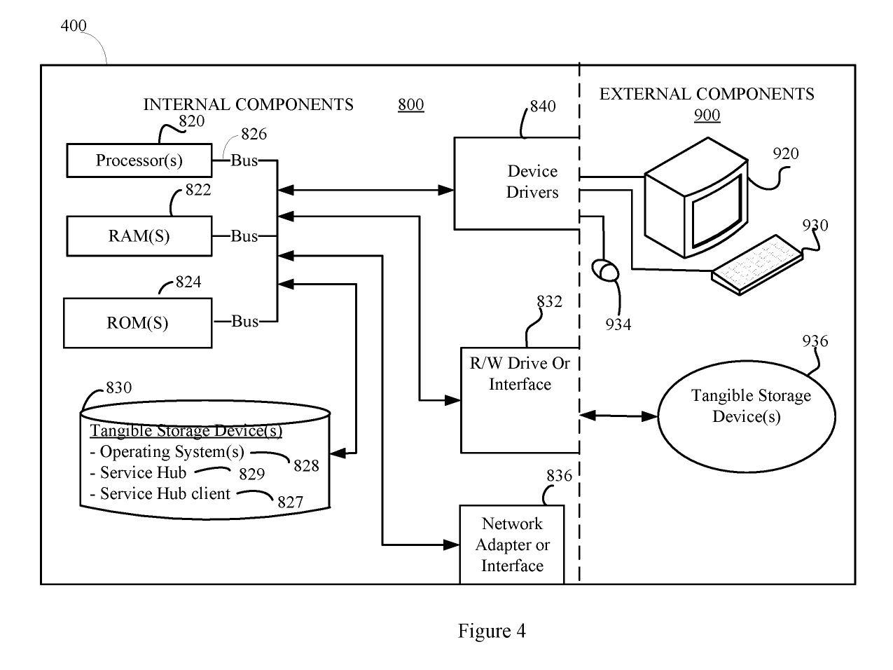

Referring now to FIG. 4, computing device 400 may include respective sets of internal components 800 and external components 900 that together may provide an environment for a software application, such as a service hub for cloud based document access. Each of the sets of internal components 800 includes one or more processors 820; one or more computer-readable RAMs 822; one or more computer-readable ROMs 824 on one or more buses 826; one or more operating systems 828; one or more software applications, 827 and 829, executing the method of FIGS. 2 and 3; and one or more computer-readable tangible storage devices 830. The one or more operating systems 828 and software applications, 827 and 829, are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 also includes a R/W drive or interface 832 to read from and write to one or more computer-readable tangible storage devices 936 such as a CD-ROM, DVD, SSD, memory stick, magnetic tape, magnetic disk, optical disk or semiconductor storage device.

Each set of internal components 800 may also include network adapters (or switch port cards) or interfaces 836 such as a TCP/IP adapter cards, wireless WI-FI interface cards, or 3G or 4G wireless interface cards or other wired or wireless communication links. The DBMS modules 829, and operating system 828 that are associated with computing device 400, can be downloaded to computing device 300 from an external computer (e.g., server) via a network (for example, the Internet, a local area network, or other wide area network) and respective network adapters or interfaces 836. From the network adapters (or switch port adapters) or interfaces 836 and operating system 828 associated with computing device 400 are loaded into the respective hard drive 830 and network adapter 836. The network may comprise copper wires, optical fibers, wireless transmission, routers, firewalls, switches, gateway computers and/or edge servers.

Each of the sets of external components 900 can include a computer display monitor 920, a keyboard 930, and a computer mouse 934. External components 900 can also include touch screens, virtual keyboards, touch pads, pointing devices, and other human interface devices. Each of the sets of internal components 800 also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Various embodiments of the invention may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

1. A method for accessing cloud based document libraries across a network, comprising:
intercepting a request from an application to access a document library before the request is executed, wherein the access is to retrieve a document from a document library, or to publish the document to the document library;
based on the request being to retrieve the document, retrieving metadata associated with the document from the document library and searching for the document in a local archive; and
based on the request being to publish a document to the document library, adding the document the local archive and publishing the document to the document library.

2. The method of claim 1, further comprising:
executing a software application in a service hub, wherein an interface of the software application is configured to read a schema of the document library, and wherein the software application queries the document library for metadata associated with the document;
searching the local archive for a local copy of the document, and based on there being the local copy, comparing the metadata from the document library to metadata of the local copy;
based on the metadata from the document library matching the metadata of the local copy, or based on a versionID of the local copy being later, discontinuing the request from the document library, and serving the local copy of the document from the local archive; and
based on the metadata not matching, or based on the versionID of the local copy being later: 1) retrieving the document from the document library; 2) adding the retrieved document to the local archive; and 3) adding an entry in the local archive to include the retrieved metadata.

3. The method of claim 1, further comprising:
updating the local archive with the local copy of the document, and updating the metadata in the local archive, wherein the updating includes incrementing the versionID;
continuing to publish the local copy of the document to the document library, based on a network connection to the document library being available; and
decrementing a number of retry attempts and deferring to publish the local copy of the document to the document library, wherein the network connection to the document library is not available and there being remaining retry attempts.

4. The method of claim 1, wherein the metadata varies depending on the document library, and includes:
a documentID; a document name; the versionID; a checksum; an identifier of a source of the document; document creator; creation date and time; and last access date and time.

5. The method of claim 1, wherein the document includes a text document, a video, a photo, and an audio file.

6. The method of claim 1, wherein the service hub includes a plurality of interfaces, each corresponding to plurality of software applications includes a web browser plugin, a java application, and a native application.

7. The method of claim 1, further comprising a configurable profile, wherein the profile includes the number of retry attempts, a preferred time window for attempting the network connection, and an amount of time between each retry attempt.

8. The method of claim 1, wherein a service hub manages a plurality of concurrent accesses to multiple document libraries without blocking.

9. A computer program product for accessing cloud based document libraries across a network, comprising:
program instructions to intercept a request from an application to access a document library before the request is executed, wherein the access is to retrieve a document from a document library, or to publish the document to the document library;
based on the request being to retrieve the document, program instructions to retrieve metadata associated with the document from the document library and search for the document in a local archive; and
based on the request being to publish a document to the document library, program instructions to add the document the local archive and publish the document to the document library.

10. The computer program product of claim 9, further comprising:
program instructions to execute a software application in a service hub, wherein an interface of the software application is configured to read a schema of the document library, and wherein the software application queries the document library for metadata associated with the document;
program instructions to search the local archive for a local copy of the document, and based on there being the local copy, to compare the metadata from the document library to metadata of the local copy;
based on the metadata from the document library matching the metadata of the local copy, or based on a versionID of the local copy being later, program instructions to discontinue the request from the document library, and to serve the local copy of the document from the local archive; and
based on the metadata not matching, or based on the versionID of the local copy being later, program instructions to: 1) retrieving the document from the document library; 2) adding the retrieved document to the local archive; and 3) adding an entry in the local archive to include the retrieved metadata.

11. The computer program product of claim 9, further comprising:
program instructions to update the local archive with the local copy of the document, and to update the metadata in the local archive, wherein the updating includes incrementing the versionID;
program instructions to continue to publish the local copy of the document to the document library, based on a network connection to the document library being available; and
program instructions to decrement a number of retry attempts and deferring to publish the local copy of the document to the document library, wherein the network connection to the document library is not available and there being remaining retry attempts.

12. The computer program product of claim 9, wherein the metadata varies depending on the document library, and includes:
a documentID; a document name; the versionID; a checksum; an identifier of a source of the document; document creator; creation date and time; and last access date and time.

13. The computer program product of claim 9, wherein the service hub includes a plurality of interfaces, each corresponding to plurality of software applications includes a web browser plugin, a java application, and a native application.

14. A computer system for accessing cloud based document libraries across a network, comprising,
one or more processors, one or more tangible computer-readable storage devices, and a plurality of program instructions stored on at least one of the one or more storage devices for execution by at least one of the one or more processors, the plurality of program instructions comprising:
intercepting a request from an application to access a document library before the request is executed, wherein the access is to retrieve a document from a document library, or to publish the document to the document library;
based on the request being to retrieve the document, retrieving metadata associated with the document from the document library and searching for the document in a local archive; and
based on the request being to publish a document to the document library, adding the document the local archive and publishing the document to the document library.

15. The computer system of claim 14, further comprising:
executing a software application in a service hub, wherein an interface of the software application is configured to read a schema of the document library, and wherein the software application queries the document library for metadata associated with the document;
searching the local archive for a local copy of the document, and based on there being the local copy, comparing the metadata from the document library to metadata of the local copy;
based on the metadata from the document library matching the metadata of the local copy, or based on a versionID of the local copy being later, discontinuing the request from the document library, and serving the local copy of the document from the local archive; and
based on the metadata not matching, or based on the versionID of the local copy being later: 1) retrieving the document from the document library; 2) adding the retrieved document to the local archive; and 3) adding an entry in the local archive to include the retrieved metadata.

16. The computer system of claim 14, further comprising:
updating the local archive with the local copy of the document, and updating the metadata in the local archive, wherein the updating includes incrementing the versionID;
continuing to publish the local copy of the document to the document library, based on a network connection to the document library being available; and
decrementing a number of retry attempts and deferring to publish the local copy of the document to the document library, wherein the network connection to the document library is not available and there being remaining retry attempts.

17. The computer system of claim 14, wherein the metadata varies depending on the document library, and includes:
a documentID; a document name; the versionID; a checksum; an identifier of a source of the document; document creator; creation date and time; and last access date and time.

18. The computer system of claim 14, wherein the document includes a text document, a video, a photo, and an audio file.

19. The computer system of claim 14, further comprising a configurable profile, wherein the profile includes the number of retry attempts, a preferred time window for attempting the network connection, and an amount of time between each retry attempt.

20. The computer system of claim 14, wherein a service hub manages a plurality of concurrent accesses to multiple document libraries without blocking.
